(19) United States
(12) Patent Application Publication
(10) Pub. No.: US 2012/0280435 A1
(43) Pub. Date: Nov. 8, 2012

(54) ACTIVE MATERIALS FOR LITHIUM-ION BATTERIES

(75) Inventors: Ou Mao, Mequon, WI (US); Feng Li, Troy, MI (US); On Chang, San Jose, CA (US); Dania Ghantous, Walnut Creek, CA (US); George Blomgren, Lakewood, OH (US)

(73) Assignee: Basvah, LLC, Menlo Park, CA (US)

(21) Appl. No.: 13/505,739

(22) PCT Filed: Nov. 1, 2010
(86) PCT No.: PCT/US10/55008

§ 371 Date: Jul. 23, 2012

Related U.S. Application Data
(60) Provisional application No. 61/257,428, filed on Nov. 2, 2009.

(51) Int. Cl. H01B 1/08; H01M 4/04

(52) U.S. Cl. 264/681; 252/519.15

(57) ABSTRACT

Methods for forming a cathode active material comprise sintering flakes formed from a nickel, manganese, cobalt and lithium-containing slurry to form the cathode material having the formula Li₂Ni_{1-x-y}MnₓCo_{y}O₂, wherein ‘x’ is a number between about 0 and 1, ‘y’ is a number between about 0 and 1, and ‘z’ is a number greater than or equal to about 0.8 and less than 1. Lithium-ion batteries having cathode active materials formed according to methods of embodiments of the invention are provided.

### FIELD OF THE INVENTION

The invention generally relates to lithium-ion batteries, more particularly to lithium transition metal oxide materials for use as positive electrodes or cathode materials of lithium-ion batteries.

### BACKGROUND OF THE INVENTION

Lithium-ion batteries typically include an anode, an electrolyte and a cathode that contains lithium in the form of a lithium-transition metal oxide. Examples of transition metal oxides that have been used include cobalt dioxide, nickel dioxide, and manganese dioxide. These materials, however, lack high initial capacity, high thermal stability and preferable capacity retention after repeated charge-discharge cycles.

Li transition metal oxides have been used in most of commercial lithium-ion batteries as cathode materials. The traditional cathode material is typically formed of LiCoO₂, which may be used in portable electronic devices, such as cell phones, laptop computers and digital cameras. The recent thrust in the development of lithium-ion batteries has been to develop high performance, safe and low-cost batteries for electric vehicles and grid storage. The cathode materials, which may be referred to as the active materials in lithium-ion batteries, may critically contribute to battery performance and cost. Research has been focused on developing cathode materials beyond those comprising LiCoO₂.

Further, in certain lithium mixed metal oxide materials containing Ni, Mn and Co, after the first (1^{st}) cycle the mixed metal oxides may have a relatively high irreversible capacity loss. Although these oxides may have high capacity, high thermal stability and lower cost due to less Co (in relation to the Co content in LiCoO₂), the high irreversible capacity loss is undesirable. For instance, after the first cycle the mixed metal oxides may have an irreversible capacity loss exceeding 10%. Such high irreversible loss has been shown research work, such as, for example, Wilcox et al., “Structure and Electrochemistry of LiNi_{1/3}Co_{1/3-y}M_{y}Mn_{1/3}O₂ (M=Ti, Al, Fe) Positive Electrode Materials,” Journal of The Electrochemical Society, Vol 156, p. A195 (2009). A high 1st cycle irreversible capacity loss may increase the cost of batteries and hinder the design and production of high capacity batteries.

There is therefore a need in the art for improved cathode materials for use in lithium-ion batteries.

### SUMMARY OF THE INVENTION

According to certain prior art methods, use of flakes of metal oxide as cathode active materials may give rise to very high power batteries, which may maintain high energy. See, e.g., U.S. Pat. Nos. 6,337,156 and 6,682,849 to Narang et al.

Active material flakes may be formed via sintering “green” flakes that include agglomerates of smaller primary particles. These flakes are often characterized as being in a “green” state prior to sintering. The sintering may occur in a heating apparatus, such as an oven or furnace, so as to bring about the physical joining of the primary particles and provide inter-particle connectivity. For example, primary particles of lithium nickel manganese cobalt oxide (NMC) active material may be sintered under various conditions, which result in the physical joining of active material particles, thus forming higher order flakes.

Generally, flake sintering (also “sintering” herein) is a heat treatment that is in addition to the heat treatment for the fabrication of the NMC of the primary particles. Furthermore, flake sintering requires longer times and/or higher temperature as compared to the conditions for fabricating the NMC of the primary particles, which increases the cost, time and risk of degradation of materials via lithium loss.

In embodiments of the invention, alternative processes to make the flake materials for Li-ion batteries are provided. These processes include: use of precursor compounds, that is, nickel, cobalt and manganese salts (e.g., carbonates, nitrates, sulfates) via a co-precipitation synthesis route to prepare a NiMnCo intermediate precursor; mixing the intermediate precursor with appropriate stoichiometry of lithium compound (for example, lithium carbonate) and a binder in a certain solvent; coating the slurry on a releasing substrate to form a green flake; and sintering the green flake to fabricate the lithium nickel manganese cobalt oxide (also “NMC” herein), the cathode active material. In embodiments, the advantages of this alternative synthesis process include reduced cost due to one less heat treatment process and lower sintering temperature and shorter time; increased capacity by ˜3% due to better control of Li content in the flakes and lower mixing between Li and Ni sites at lower sintering temperature; and improved flake morphology with smaller primary particle size and internal pores.

In an aspect of the invention, methods for forming positive electrode or cathode materials for use in lithium-ion batteries are provided.

In embodiments of the invention, methods for forming a cathode active material comprise sintering flakes formed from a nickel, manganese, cobalt and lithium-containing slurry to form the cathode material having the formula Li_{z}Ni_{1-x-y}MnₓCo_{y}O₂, wherein ‘x’ is a number between about 0 and 1, ‘y’ is a number between about 0 and 1, and ‘z’ is a number between about 0.8 and 1.

In other embodiments of the invention, methods for producing a cathode material having the formula Li_{z}Ni_{1-x-y}MnₓCo_{y}O₂, wherein 0≦x≦1, 0≦y≦1 and 0.8≦z<1, comprise mixing a nickel (Ni) salt, manganese (Mn) salt and cobalt (Co) salt to form an intermediate precursor. The intermediate precursor may be mixed with a lithium (Li) compound, a binder and a solvent to form a slurry. A releasing substrate (also “substrate” herein) may be coated with the slurry to form a coated layer on the releasing substrate. In an embodiment, the coated layer may be dried and separated from the releasing substrate. Flakes may then be formed from the dried coated layer; the flakes may be subsequently sintered (or calcined). In an embodiment, the flakes may be crushed and filtered to form the cathode material.

In yet other embodiments of the invention, methods for forming lithium nickel manganese cobalt oxide (NMC) particles comprise forming a slurry comprising a Li compound, a binder, a solvent and an intermediate precursor having nickel (Ni), manganese (Mn) and cobalt (Co). A substrate may be coated with the slurry to form a coated layer on the substrate. The coated layer may then be dried to separate the coated layer from the substrate. The coated layer may then be shredded into green flakes. The green flakes may then be heated to form sintered flakes. The sintered flakes may be subsequently crushed to form the NMC particles. The NMC particles may be used as cathode active materials in lithium-ion batteries.

In still other embodiments of the invention, methods for producing a cathode active material comprise mixing salts of nickel (Ni), manganese (Mn) and cobalt (Co) to form an intermediate precursor; mixing the intermediate precursor with a binder and a solvent to form a slurry; applying the slurry on a releasing substrate to form green flakes; and sintering the green flakes to form the cathode active material.

In another aspect of the invention, cathode active materials for use in lithium-ion batteries are provided. In embodiments of the invention, cathode active materials having the formula Li_{z}Ni_{1-x-y}MnₓCo_{y}O₂, wherein ‘x’ is a number greater than or equal to about 0 and less than or equal to 1, ‘y’ is a number greater than or equal to about 0 and less than or equal to 1, and ‘z’ is a number greater than or equal to about 0.8 and less than 1, are provided

In yet another aspect of the invention, lithium-ion batteries having cathode active materials are provided. In embodiments of the invention, lithium-ion batteries having cathode active materials comprising Li_{z}Ni_{1-x-y}MnₓCo_{y}O₂, wherein ‘x’ is a number between about 0 and 1, ‘y’ is a number between about 0 and 1, and ‘z’ is a number less than about 1, are provided.

### BRIEF DESCRIPTION OF THE DRAWINGS

The invention will be better understood from the Detailed Description of the Invention and from the appended drawings, which are meant to illustrate and not to limit the invention.

FIG. 1 shows a flowchart for forming a cathode active material for use in a lithium-ion battery, in accordance with an embodiment of the invention;

FIG. 2 shows a flowchart for forming a slurry for use in forming a cathode active material, in accordance with an embodiment of the invention; and

FIG. 3 shows a powder x-ray diffraction (XRD) pattern of Li_{0.81}(Ni_{0.34}Mn_{0.33}Co_{0.33})O₂, in accordance with an embodiment of the invention.

### DETAILED DESCRIPTION OF THE INVENTION

The invention provides compositions and methods of manufacturing lithium-based (or lithium-containing) cathode materials for use in lithium-ion batteries. Cathode materials provided in accordance with the invention may comprise mixed metal oxides having a first (1st) cycle irreversible capacity loss lower than prior art materials. Such cathode materials (or alternatively, positive electrode materials herein) may advantageously maintain more charge after a first charge-discharge cycle. In various embodiments, cathode active materials may be capable of providing a first cycle irreversible capacity loss less than or equal to about 10%, or less than or equal to about 5%, or less than or equal to about 3%.

In embodiments of the invention, cathode materials (also “cathode active materials” herein) are provided having the formula Li_{z}Ni_{1-x-y}MnₓCo_{y}O₂, wherein ‘x’ is a number between about 0 and 1, ‘y’ is a number between about 0 and 1, and ‘z’ is a number between about 0.8 and 1.3. In some embodiments, ‘z’ is a number less than about 1, or less than or equal to about 0.95, or less than or equal to about 0.90, or less than or equal to about 0.85, or less than or equal to about 0.8. In an embodiment, ‘z’ is a number less than about 1 and greater than or equal to about 0.8.

In preferable embodiments of the invention, a lithium-based cathode material having the general formula Li_{z}Ni_{1-x-y}MnₓCo_{y}O₂ is provided. In an embodiment, the 3a sites in the crystallographic structure (R3m) are only partially occupied while maintaining the α-NaFeO₂ (O3) type of crystal structure. Preferably the lithium atoms of the as-sintered cathode material have only about 80% occupancy of the 3a sites, and the cation mixing between Li and Ni ions is less than about 5 molar %.

Lithium-based cathode materials of various embodiments of the invention are based on unexpected results. Prior art references have taught away from a lithium-based cathode material having a low lithium content when a Ni-containing oxide (such as NMC) is used in the cathode material. This could be due to cation mixing between Li and Ni in the cathode material. See, e.g., Journal of The Electrochemical Society, Vol. 149, p. A1114; Solid State Ionics, Volume 176, Issues 5-6, p.463; U.S. Patent No. 7,494,744. Cation mixing may be detrimental to the capacity of a cathode. In contrast to prior art lithium-based cathode materials, the low lithium content in lithium-based cathode materials of various embodiments of the invention provides for lower total lithium in a lithium-ion battery incorporating cathode materials of embodiments of the invention without compromising battery (or cathode) capacity, energy and power, as compared to prior art lithium mixed metal oxide materials.

In addition, the low lithium content in lithium-based cathode materials may reduce the first cycle irreversibility. In various embodiments of the invention, cathode active materials may be prepared from a slurry comprising nickel (Ni), manganese (Mn), cobalt (Co), lithium (Li), a binder and a solvent. In embodiments, Ni, Mn, Co and Li may be provided by way of one or more salts of the constituent elements. The slurry may then be applied to a releasing substrate (also “substrate” herein), dried, separated from the substrate and shredded into green flakes. The green flakes may be subsequently heated to sinter the flakes in to particles comprising cathode materials of embodiments of the invention. By forming cathode materials in such “bottoms-up” fashion (i.e., from a slurry comprising the constituent elements of the cathode active material), fewer heating steps are employed, leading to savings in processing costs. In addition, lower sintering temperatures and heating times during sintering may be employed. Use of lower sintering temperatures may minimize the mixing between Li and Ni sites, thus reducing, if not eliminating problems associated with cation mixing. Cathode active materials formed according to methods of embodiments of the invention may also benefit from improved flake morphology with adjustable particle sizes and internal pores.

In certain embodiment, the primary particle sizes may be similar. In an embodiment, primary particle sizes may be about 0.2 μm. In an embodiment, the sizes of agglomerates of the primary particles (secondary particles) may vary from about 0.5 μm to about 20 μm. In an embodiment, 6 μm particles may be used in flake formation processes of various embodiments of the invention. In such a case, the sintering temperature may be limited to temperatures above about 1000° C. Methods of embodiments of the invention and the uses of smaller particle sizes may advantageously open up the range of processing conditions, particularly at lower sintering temperatures, providing for achieving optimized flake processes and materials.

For the lithium ion cells made of the lithium-based NMC material of embodiments of the invention, the lithium content of the cathode may be less than the lithium content of current lithium-rich NMC cathodes. In some cases, the lithium content may be 5% less, or 10% less, or 15% less, 20% less than the lithium content of current lithium-rich NMC cathodes. In some embodiments, for a cathode material having the formula Li_{z}Ni_{1-x-y}MnₓCo_{y}O₂, wherein ‘x’ and ‘y’ are numbers between 0 and 1, and ‘z’ is a number less than about 1, a fully discharged cell may have a lithium content (‘z’) of about 0.75, while a fully charged cell having a voltage of about 4.2 V may have a lithium content (‘z’) as low as about 0.2. A lower lithium content (‘z’) may advantageously provide for safer cells. Under overcharging (abusive) conditions, for a cell that is charged to about 5 V, for example, the low lithium cell may have significantly less lithium metal formed than NMC cathode materials available in the art.

The terms “calcining” and “sintering”, as used herein, refer to heating a solid material to a temperature below its melting point. Calcining (or calcination) may be used to drive off volatile, chemically combined components, or to thermally induce phase transfer and decomposition. Sintering may be used to promote interparticle atomic diffusion to form interparticle connectivity.

### Methods for Forming Cathode Active Materials

In an aspect of the invention, methods for forming cathode materials for use in lithium-ion batteries are provided. In embodiments, methods for forming a cathode material may comprise sintering flakes formed from a nickel, manganese, cobalt and lithium-containing slurry to form the cathode material having the formula Li_{z}Ni_{1-x-y}MnₓCo_{y}O₂, wherein ‘x’ is a number between about 0 and 1, ‘y’ is a number between about 0 and 1, and ‘z’ is a number between about 0.8 and 1.3. In various embodiments, ‘z’ may be less than about 1, or less than or equal to about 0.95, or less than or equal to about 0.90, or less than or equal to about 0.85, or less than or equal to about 0.8.

In embodiments of the invention, a first slurry comprising a Li compound (or Li-containing compound), a binder, a solvent and an intermediate precursor comprising Ni, Mn and Co may be formed by first forming an intermediate precursor comprising Ni, Mn and Co. The intermediate precursor may be a salt comprising Ni, Mn and Co. In an embodiment, the intermediate precursor may be (Ni_{1-x-y}CoₓMn_{y})CO₃, wherein ‘x’ is a number between about 0 and 1 and ‘y’ is a number between about 0 and 1. The intermediate precursor may be formed by co-precipitating salts of Ni, Mn and Co. The intermediate precursor may then be mixed with the binder and solvent to form a second slurry. The Li compound (e.g., a lithium-containing salt, such as Li₂CO₃) may then be added to the second slurry to form the first slurry. Alternatively, the Li compound may be mixed with the intermediate precursor prior to mixing the intermediate precursor with the binder and the solvent. The lithium compound may be a lithium salt. A mixture comprising the Li compound and the intermediate may then be combined with the binder and the solvent to form the first slurry. In such a case, formation of the second slurry may not be necessary. The first slurry thus formed is capable of providing cathode materials having the formula Li_{z}Ni_{1-x-y}MnₓCo_{y}O₂, wherein ‘x’ is a number between about 0 and 1, ‘y’ is a number between about 0 and 1, and ‘z’ is a number between about 0.8 and 1.3. In some embodiments, ‘z’ may be less than about 1.

In certain embodiments, upon forming the intermediate precursor, the intermediate precursor may be dried prior to combining with a lithium compound, a binder and a solvent. In an embodiment, prior to combining the intermediate precursor with the lithium compound, the binder and the solvent, the intermediate precursor may be dried (in vacuum or air) at a temperature greater than or equal to about 50° C., or greater than or equal to about 100° C., for a time period greater than or equal to about 30 minutes, or greater than or equal to about 60 minutes, or greater than or equal to about 5 hours, or greater than or equal to about 10 hours.

In certain embodiments, prior to forming a slurry, the intermediate precursor may be mixed with a lithium compound and heated in vacuum or air. In an embodiment, the intermediate precursor may be mixed with the lithium compound and heated at a temperature greater than or equal to about 400° C., or greater than or equal to about 500° C., for a time period greater than or equal to about 10 minutes, or greater than or equal to about 30 minutes. This forms a mixture comprising Ni, Mn, Co and Li, which may subsequently be combined with a binder and a solvent to form the slurry.

The slurry may then be used to form a flake comprising Li_{z}Ni_{1-x-y}MnₓCo_{y}O₂, wherein 0≦x≦1, 0≦y≦1 and 0.8≦z≦1.3. In certain embodiments, ‘z’ is a number less than about 1, or less than or equal to about 0.95, or less than or equal to about 0.9, or less than or equal to about 0.85, or less than or equal to about 0.8. In an embodiment, ‘z’ is a number less than about 1 and greater than or equal to about 0.8. In embodiments, the slurry may be applied to a releasing substrate to form a coated layer. The coated layer may then be dried. The dried coated layer may then be removed from the releasing substrate and shredded or broken into green flakes. The green flakes may then be heated (sintered) to form one or more sintered flakes. The one or more sintered flakes may be larger than the flakes prior to sintering. The one or more sintered flakes may then be crushed into smaller pieces and employed for use as cathode active materials.

Flakes formed in accordance with this aspect of the invention may vary in size depending on various conditions. As known to those of skill in the field, these flakes may be observed through SEM photographs to study and determine the actual flake sizes on a mass (or number) average basis. It is preferable to classify or categorize the flakes or elongated structures herein according to their sizes with conventional separation systems and methodologies.

Reference will now be made to the figures, wherein like numerals refer to like parts throughout. It will be appreciated that the figures are not necessarily drawn to scale.

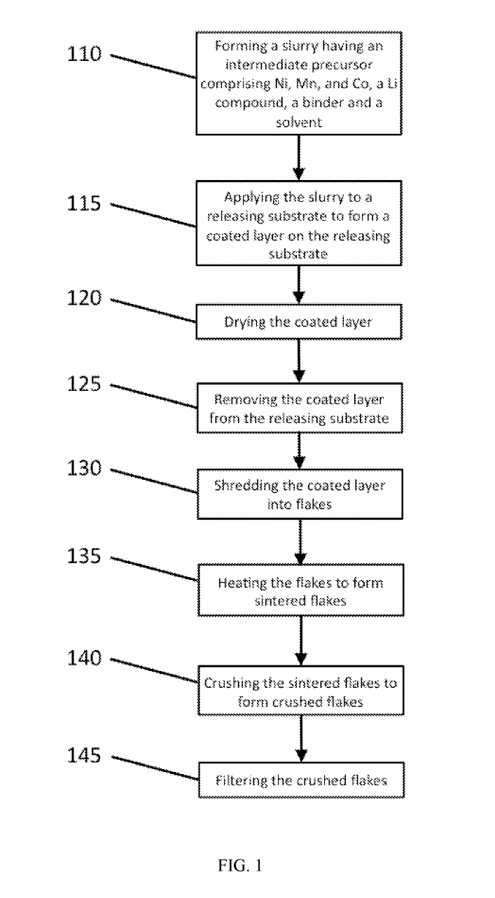

With reference to FIG. 1, a method for producing a cathode material having the formula Li_{z}Ni_{1-x-y}MnₓCo_{y}O₂, wherein 0≦x≦1, 0≦y≦1 and 0.8≦z≦1.3, is provided. In certain embodiments, ‘z’ is a number less than about 1, or less than or equal to about 0.95, or less than or equal to about 0.9, or less than or equal to about 0.85, or less than or equal to about 0.8. In an embodiment, ‘z’ is a number less than about 1 and greater than or equal to about 0.8. In step 110, the method comprises forming a slurry having an intermediate precursor, a lithium compound, a binder and a solvent. In a preferable embodiment, the intermediate precursor comprises nickel (Ni), manganese (Mn) and cobalt (Co). In an embodiment, the intermediate precursor is formed via co-precipitation synthesis of salts of Ni, Mn and Co. In an embodiment, the intermediate precursor may be formed by co-precipitating one or more salts of Ni, one or more salts of Mn and one or more salts of Co. The one or more of salts of Ni, Mn and Co may be selected from the group consisting of nitrates, chlorides, sulfates and acetates. In some cases, multiple salts may be used to provide Ni, Mn or Co. For example, NiNO₃ and NiSO₄ may be used to provide Ni during the co-precipitation synthesis of the intermediate precursor.

During formation of the intermediate precursor, the quantity (or amount) of Ni, Mn and Co in solution is selected so as to yield a cathode material having a desirable composition, i.e., ‘x’ and ‘y’ in Li_{z}Ni_{1-x-y}MnₓCo_{y}O₂ are selected as desired. The amount of Ni, Mn and Co in solution may be controlled by the amount (or relative proportion) of Ni salts, Mn salts and Co salts used to form the intermediate precursor. In addition, the amount of the lithium compound added to the slurry is selected so as to yield a desirable lithium composition (‘z’) in the Li_{z}Ni_{1-x-y}MnₓCo_{y}O₂ cathode material. In certain embodiments, the amount of lithium compound added is such that ‘z’ is a number less than about 1, or less than or equal to about 0.95, or less than or equal to about 0.9, or less than or equal to about 0.85, or less than or equal to about 0.8. In an embodiment, ‘z’ is a number less than about 1 and greater than or equal to about 0.8.

The binder may include one or more of gelatin, cellulose, cellulose derivatives, polyvinylpyrrolidone (PVP), polyvinyl acetate (PVA), starch, sucrose and polyethylene glycol. In a preferable embodiment, the binder is PVP. The solvent for forming the slurry may include one or more of water and alcohols, such as, e.g., methanol, ethanol, propanol (e.g., isopropanol) and butanol. In a preferable embodiment, the solvent for forming the slurry is isopropanol (isopropyl alcohol). The Li compound may include a lithium-containing salt. In an embodiment, the Li compound may include one or more of lithium carbonate, lithium hydroxide, lithium nitrate and lithium acetate. In a preferable embodiment, the Li compound is lithium carbonate.

In an alternative embodiment, the intermediate precursor may be mixed with the Li compound prior to forming the slurry. In such a case, the slurry may be formed by bringing a mixture having the Li compound and the intermediate precursor in contact with the binder and the solvent.

It will be appreciated that methods for forming the slurry may include mixing the intermediate precursor, the Li compound, the binder and the solvent in a mixing apparatus. In some cases, the binder may be added after mixing the Li compound, the intermediate precursor and the solvent. In other cases, the Li compound may be added after mixing the intermediate precursor, the solvent and the binder.

With continued reference to FIG. 1, in step 115, a releasing substrate (also “substrate” herein) is coated with the slurry to form a coated layer on the substrate. In such a case, the slurry may be applied to the releasing substrate via various means, such as, e.g., using a brush, a “doctor blade”, or an industrial coating machine, for example, a reverse roll or comma bar coater to coat the releasing substrate with the slurry. In an embodiment, the releasing substrate is a polymeric material, such as, e.g., plastic. In some cases, the releasing substrate may include a layer of a polymeric material over a supporting material, such as wood or metal (e.g., aluminum). For instance, the releasing substrate may be an aluminum block coated with plastic.

Next, in step 120, the coated layer is dried and separated from the releasing substrate. In an embodiment, the coated layer may be dried in air at room temperature (about 25° C.). In another embodiment, the coated layer may be dried in air via the application of heat. In such a case, one or more of convective, radiative or conductive heating methods may be employed to dry the coated layer. For instance, air having a temperature greater than 25° C. may be directed over the coated layer. In an embodiment, as the releasing substrate dries, it separates from the releasing substrate. Next, in step 125, when the coated layer has separated from the releasing substrate, it is removed from the releasing substrate.

With continued reference to FIG. 1, in step 130, the dried coated layer (or large flake) may be shredded into small flakes. Each flake has a surface area that is smaller than the surface area of the dried coated layer. The dried coated layer may be shredded using, e.g., a mechanical shredder or crusher, or forcing through a screen of appropriate mesh size. In an embodiment, the flakes prior to sintering may be referred to as “green flakes.”

Next, in step 135, the flakes may be heated to sinter the flakes to form one or more sintered flakes. Upon heating, the flakes may agglomerate to form one or more larger flakes. Sintering (or calcining) the flakes may include heating the flakes at a temperature less than or equal to about 1100° C., or less than or equal to about 1000° C., or less than or equal to about 900° C., for a time period greater than or equal to about 1 minute, or greater than or equal to about 10 minutes, or greater than or equal to about 60 minutes, or greater than or equal to about 5 hours, or greater than or equal to about 10 hours, or greater than or equal to about 20 hours. The flakes may be heated in a heating apparatus, such as, e.g., a heating oven or a furnace. Heating the flakes may effect the physical joining of the primary particles that comprise the flakes and provide inter-particle connectivity.

With continued reference to FIG. 1, in step 140, the one or more sintered flakes may be subsequently crushed to form particles comprising Li_{z}Ni_{1-x-y}MnₓCo_{y}O₂ (NMC), wherein ‘x’ is a number greater than or equal to about 0 and less than 1, ‘y’ is a number greater than or equal to about 0 and less than 1, and ‘z’ is a number greater than or equal to about 0.8 and less than 1.3. In some embodiments, ‘z’ is a number greater than or equal to about 0.8 and less than about 1. Next, in step 145, the particles may be filtered to obtain a predetermined (or desired) NMC particle size distribution. The NMC particles thus formed may comprise cathode materials for use in lithium-ion batteries.

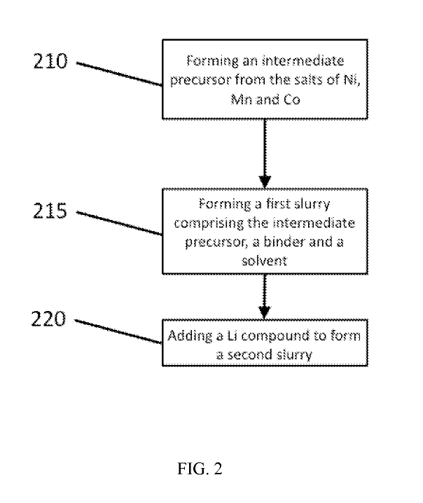

With reference to FIG. 2, in an alternative embodiment, the slurry for forming the cathode active material (see above) may be formed by first forming a first slurry comprising the intermediate precursor, a binder and a solvent, and subsequently adding to the first slurry a Li compound to form a second slurry.

With reference to FIG. 2, in step 210, an intermediate precursor may be formed from one or more salts of Ni, Mn and Co. In an embodiment, the intermediate precursor may be formed by co-precipitating one or more salts of Ni, Mn and Co. The one or more of salts of Ni, Mn and Co may be selected from the group consisting of nitrates, chlorides, sulfates and acetates. In some cases, multiple salts may be used to provide Ni, Mn or Co in the intermediate precursor. For example, NiNO₃ and NiSO₄ may be used to provide Ni during the co-precipitation synthesis of the intermediate precursor.

Next, in step 215, a first slurry may be formed by mixing the intermediate precursor with a binder and a solvent. The order of combination of the constituent elements of the first slurry may be selected as desired. For example, the intermediate precursor, binder and solvent may be combined simultaneously or substantially simultaneously to form the first slurry. As another example, the intermediate precursor and solvent may be combined first, and the binder may be added thereafter to form the first slurry.

The binder may include one or more of gelatin, cellulose, cellulose derivatives, polyvinylpyrrolidone (PVP), polyvinyl acetate (PVA), starch, sucrose and polyethylene glycol. In a preferable embodiment, the binder is PVP. The solvent for forming the slurry may include one or more of water and alcohols, such as, e.g., methanol, ethanol, propanol (e.g., isopropanol) and butanol. In a preferable embodiment, the solvent for forming the slurry is isopropanol.

Next, in step 220, a lithium compound is added to the first slurry to form a second slurry. The Li compound may include a lithium-containing salt. In an embodiment, the Li compound may include one or more of lithium carbonate, lithium hydroxide, lithium nitrate and lithium acetate. In a preferable embodiment, the Li compound is lithium carbonate. The second slurry may then be used to form a cathode active material, as described above (see, e.g., steps 115-145 of FIG. 1).

It will be appreciated that in forming the slurries described above, various mixing methods may be employed. For example, when an intermediate precursor is mixed with a solvent and a binder, a stirring or mixing mechanism may be employed to provide sufficient mixing of the constituent elements of the slurry. In an embodiment, the slurry may be formed in a stirred tank reactor, such as a continuous stirred tank reactor (CSTR). Various properties of the slurry upon mixing may be monitored and controlled to form a slurry having properties as desired. For instance, during mixing, the slurry temperature and pH may be monitored and controlled.

### Cathode Active Material and Lithium-Ion Batteries

In another aspect of the invention, cathode active materials for use in lithium-ion batteries are provided. In embodiments, the cathode active materials have the formula Li_{z}Ni_{1-x-y}MnₓCo_{y}O₂, wherein ‘x’, ‘y’ and ‘z’ are numbers, and wherein 0≦x≦1, 0≦y≦1 and 0.8≦z<1. In various embodiments, ‘z’ is a number less than about 1, or less than or equal to about 0.95, or less than or equal to about 0.9, or less than or equal to about 0.85, or less than or equal to about 0.8. In an embodiment, ‘z’ is a number less than about 1 and greater than or equal to about 0.8.

In embodiments of the invention, the cathode active material is capable of providing a first cycle irreversible capacity loss less than or equal to about 10%, or less than or equal to about 5%, or less than or equal to about 3%.

Cathode active materials of embodiments of the invention may be formed via any methods described above, such as the method described in the context of FIGS. 1 and 2.

In another aspect of the invention, cathode active materials formed according to methods of embodiments of the invention may be used as cathode materials of lithium-ion batteries. In embodiments, lithium-ion batteries are provided having a cathode comprising Li_{z}Ni_{1-x-y}MnₓCo_{y}O₂, wherein ‘x’ is a number between about 0 and 1, ‘y’ is a number between about 0 and 1, and ‘z’ is a number less than about 1. In embodiments, ‘z’ may be less then or equal to about 0.95, or less than or equal to about 0.9, or less than or equal to about 0.85, or less than or equal to about 0.8. Lithium-ion batteries having cathode materials of embodiments of the invention may be capable of providing a first cycle irreversible capacity loss less than or equal to about 10%, or less than or equal to about 5%, or less than or equal to about 3%.

Cathode active materials and lithium-ion batteries comprising cathode active materials of embodiments of the invention may have the same or higher discharge capacity in relation to prior art cathode materials and lithium-ion batteries. In an embodiment, cathode active materials and lithium-ion batteries comprising cathode active materials of embodiments of the invention may have a capacity that is increased by as much as 3% or higher in relation to prior art cathode materials and lithium-ion batteries.

It will be appreciated that lithium-ion batteries formed from cathode materials of aspects and embodiments of the invention may comprise any anode, separator and electrolyte material suitable for optimizing the performance of such lithium-ion batteries. The cathode electrode may have a coating with the cathode active material of the invention, carbon black, and PVDF binder coated on the positive collector of aluminum foil. The anode electrode may have a coating with an active material of graphite, carbon black, and PVDF binder coated on the negative collector of copper foil. The separator may be 20 vim thick, for example, Celgard 2320. The electrodes and the separators may be arranged in various arrangements. The electrolyte may contain 1.3 M LiPF₆ in EC/EMC/DMC (1:1:1 ratio, by weight). In some cases, the electrolyte may contain VC or other additive.

In some embodiments, a band-shaped electrode may be laminated by winding itself spirally so that the side of the band-shaped electrode results in a flush wound end surface, in a jellyroll configuration to form a battery. Such bands may be of different dimensions such as lengths and thicknesses and heights, which may result in a battery in a jellyroll configuration of varying diameters. In some embodiments of the invention, the jellyroll batteries may be circular in cross-section, or may be spirally wound with other cross-sections, such as ovals, rectangles, or any other shape.

In some instances, the battery may have a cylindrical cell format, or a prismatic cell format, such as a 18650 cylindrical cell format, 26650 cylindrical cell format, 32650 cylindrical cell format, or 633450 prismatic cell format.

### EXAMPLE 1

Flakes were prepared using a (Ni_{1/3}Co_{1/3}Mn_{1/3})CO₃ carbonate precursor, which was synthesized by the co-precipitation method. An aqueous solution of NiSO₄, CoSO₄, and MnSO₄ (Ni:Mn:Co=1:1:1 molar ratio) with a concentration of 2M was pumped into stirred tank reactor. A 2M aqueous solution of Na₂CO₃ and a solution of NH₄OH as a chelating agent were also fed into the reactor. The stirring speed and the pH value were carefully controlled throughout the mixing process. The spherical (Ni_{1/3}Co_{1/3}Mn_{1/3})CO₃ powder obtained was washed and filtered, and dried in a vacuum oven overnight at a temperature of about 100° C. A lithium compound, Li₂CO₃, was thoroughly mixed with the precursor (Ni_{1/3}CO_{1/3}Mn_{1/3})CO₃. The mixture was first heated at a temperature of about 55° C. for about 30 minutes in air and subsequently mixed with an 8 wt % PVP (binder) and isopropyl alcohol (IPA) to obtain a slurry. The slurry was coated on a plastic film (releasing substrate) to form a coated layer on the plastic film. The coated layer was then heated and peeled off of the plastic film. Then the peeled coated layer (flake) was calcined at about 900° C. for about 10 hours in air to obtain an Li(NiCoMn)O₂ flake. The metal elements were analyzed by Inductively Coupled Plasma Optical Emission Spectroscopy (ICP-OES) which showed the flake as having about 0.343 atm % Ni, 0.325 atm % Mn, 0.333 atm % Co and 0.813 atm % Li—i.e., the flake comprised Li_{0.81}(Ni_{0.34}Mn_{0.33}Co_{0.33})O₂.

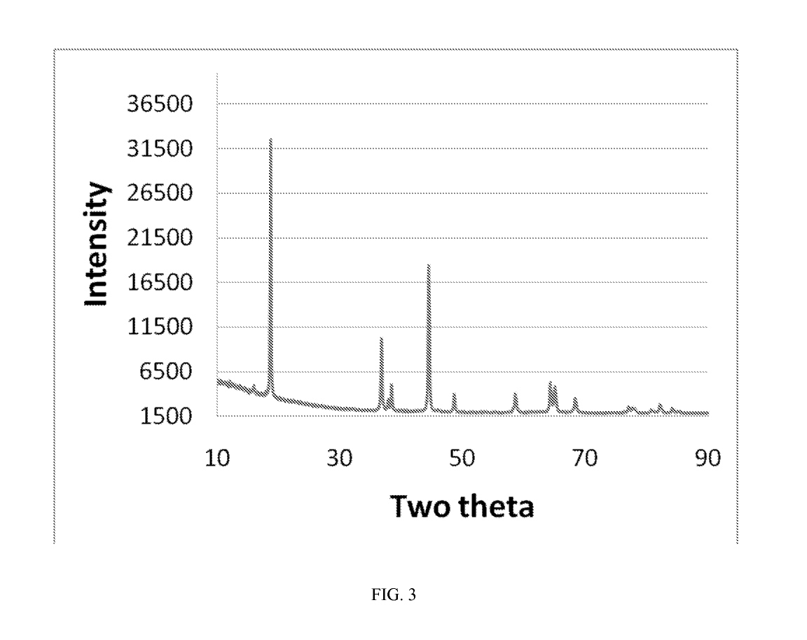

Next, the flake was ground and placed on a zero background holder and put into a Philips X'Pert MPD pro diffractometer, which used Cu radiation at 45 KV/40 mA. XRD scans were taken over the range of 10° to 90° with a step size of 0.0158° . An XRD scan is shown in FIG. 3. All strong diffraction peaks were indexed with a rhombohedral lattice (R-3m).

The electrochemical properties of the NMC powder were evaluated using CR2032 type coin cells assembled in an argon filled glove box and tested at room temperature. The positive electrode included about 80 wt % oxide powder (formed as described above), 10 wt % carbon black, and 10 wt % polyvinylidene fluoride binder coated onto an aluminum foil. Lithium foil was used as the negative electrode. Cells A, B and C used an electrolyte having about 1.3 M LiPF₆ in a mixture of EC, DMC, and EMC (1:1:1 v/v) with 1 wt % VC. Cells D, E and F used an electrolyte having about 1.2 M LiPF₆ in a mixture of EC and EMC (3:7 by weight). The coin cells were charged-discharged at a C/10 rate within a range of 2.5-4.3V at the room temperature. The results are shown in Table 1.

TABLE 1
6 coin cell test results for the first (1st) charge and discharge.

| Cells | A | B | C | D | E | F |
|---|---|---|---|---|---|---|
| 1st charge (mAh/g) | 162.9 | 163.5 | 165.1 | 165.3 | 166.3 | 166.7 |
| 1st discharge (mAh/g) | 158.5 | 158.3 | 160.4 | 160.1 | 160.3 | 161.5 |
| Irreversible loss (%) | 2.7 | 3.2 | 2.9 | 3.1 | 3.6 | 3.1 |

### Example 2

Experiments were conducted to determine the irreversible losses of cathode materials as a function of the Li content of the cathode materials. Slurries were formed according to the methods described above, but for each cell (see FIG. 2) a slurry having a predetermined lithium content was prepared. The lithium content was selected by varying the amount of Li₂CO₃ used to form each of the slurries. Cathode materials were then prepared as described above to form flakes having the general formula Li_{z}Ni_{1-x-y}MnₓCo_{y}O_{2,}, wherein ‘x’ is a number between about 0 and 1, ‘y’ is a number between about ‘0’ and 1, and ‘z’ is selected based on the amount (or quantity) of Li₂CO₃ used to form the flakes. Following heating treatment (sintering), the flakes were tested to determine the irreversible losses of the cathode materials incorporating each of the flakes. Results from the experiments are shown in Table 2. As shown in Table 2, for a flake having a lithium content (‘z’) of about 0.95, an irreversible loss of about 5.0 (i. e. , 5.0%) was obtained. The irreversible loss increased as the lithium content of the cathode materials increased.

TABLE 2
Coin cell test results for cathode materials
with different lithium content.

| | Adjust lithium content in the cathode material | |
|---|---|---|
| | Li_{0.95}(Ni_{0.34}Mn_{0.33}Co_{0.33})O₂ | Li_{1.0}(Ni_{0.34}Mn_{0.33}Co_{0.33})O₂ |
| 1^{st} charge | 170.9 | 180.4 |
| capacity | | |
| (mAh/g) | | |
| 1^{st} discharge | 162.4 | 163.9 |
| (mAh/g) | | |
| Irreversible | 5.0 | 9.2 |
| loss (%) | | |

All concepts of the invention may utilize, be incorporated in, or be integrated with other lithium mixed metal oxide materials, including, but not limited to, those described in U.S. Pat. No. 6,677,082 (“Lithium metal oxide electrodes for lithium cells and batteries”), issued on Jan. 13, 2004, U.S. Pat. No. 6,680,143 (“Lithium metal oxide electrodes for lithium cells and batteries”), issued on Jan. 20, 2004, U.S. Pat. No. 6,964,828 (“Cathode compositions for lithium-ion batteries”), issued on Nov. 15, 2005, U.S. Pat. No. 7,078,128 (“Cathode compositions for lithium-ion batteries”), issued on Jul. 18, 2006, and U.S. Pat. No. 7,205,072 (“Layered cathode materials for lithium ion rechargeable batteries”), issued on Apr. 17, 2007, which are entirely incorporated herein by reference.

It will be appreciated that methods and compositions, as described herein, may used to form other lithium-containing cathode materials for lithium-based cells (or batteries), such as lithium titanium oxide (LTO) cathode materials and lithium iron phosphate (LFP) cathode materials.

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for forming a cathode material for use in a lithium-ion battery, the method comprising sintering flakes formed from a nickel, manganese, cobalt and lithium-containing slurry to form the cathode material having the formula Li_{z}Ni_{1-x-y}MnₓCo_{y}O₂, wherein ‘x’ is a number between about 0 and 1, ‘y’ is a number between about 0 and 1, and ‘z’ is a number greater than or equal to about 0.8 and less than 1.

2. A method for producing a cathode material having the formula Li_{z}Ni_{1-x-y}MnₓCo_{y}O₂, wherein 0≦x≦1, 0≦y≦1 and 0.8≦z<1, the method comprising:
mixing a nickel (Ni) salt, manganese (Mn) salt and cobalt (Co) salt to form an intermediate precursor;
mixing the intermediate precursor with a lithium (Li) compound, a binder and a solvent to form a slurry;
coating a releasing substrate with the slurry to form a coated layer;
forming flakes from the coated layer; and
sintering the flakes to form the cathode material.

3. The method of claim 2, further comprising drying the coated layer and separating the coated layer form the substrate prior to forming flakes.

4. The method of claim 2, wherein forming flakes comprises shredding the coated layer.

5. The method of claim 2, wherein the intermediate precursor is formed from salts of Ni, Mn and Co via coprecipitation synthesis.

6. The method of claim 2, wherein the Li compound includes a lithium-containing salt.

7. The method of claim 2, wherein one or more of the Ni salt, Mn salt and Co salt are selected from the group consisting of nitrates, chlorides, hydroxides, carbonates, sulfates and acetates.

8. The method of claim 2, wherein the solvent is selected from the group consisting of water, methanol, ethanol, propanol, butanol and combinations thereof.

9. The method of claim 2, wherein sintering the flakes comprises heating the flakes at a temperature less than or equal to about 1100° C.

10. The method of claim 2, wherein sintering the flakes comprises heating the flakes at a temperature less than or equal to about 1000° C.

11. The method of claim 2, wherein the binder includes poly vinyl pyrrolidone (PVP).

12. The method of claim 2, wherein the releasing substrate comprises a polymeric material.

13. A method for forming lithium nickel manganese cobalt oxide (NMC) particles, comprising
forming a slurry comprising a Li compound, a binder, a solvent and an intermediate precursor having nickel (Ni), manganese (Mn) and cobalt (Co);
coating a substrate with the slurry to form a coated layer on the substrate;
drying the coated layer to separate the coated layer from the substrate;
shredding the coated layer into flakes;
heating the flakes to form sintered flakes; and
crushing the sintered flakes to form the NMC particles.

14. The method of claim 13, wherein the intermediate precursor is formed from salts of Ni, Mn and Co.

15. The method of claim 14, wherein the intermediate precursor is formed by co-precipitating the salts of Ni, Mn and Co.

16. The method of claim 13, further comprising removing the coated layer from the substrate after drying the coated layer.

17. The method of claim 13, further comprising filtering the NMC particles after crushing the sintered flakes to obtain a predetermined NMC particle size distribution.

18-25. (canceled)
